(19) United States
(12) Patent Application Publication
(10) Pub. No.: US 2008/0307947 A1
(43) Pub. Date: Dec. 18, 2008

(54) Easy learn music notation system

(76) Inventor: Eugene J. Bakke, Greenfield, WI (US)

Correspondence Address: Bruce Holman III, 7832 W. Lorraine Place, Milwaukee, WI, 53222, US

(21) Appl. No.: 12/154,798

(22) Filed: May 27, 2008

Related U.S. Application Data
(63) Continuation-in-part of application No. 29/225,226, filed on Mar. 11, 2005, now Pat. No. D521169.
Application No. 29/225,226 is a continuation-in-part of application No. 29/225,266, filed on Mar. 15, 2005, now abandoned.

(51) Int. Cl. G09B 15/02

(52) U.S. Cl. 84/483.2

(57) ABSTRACT

An improved music notation system for songs is disclosed that is suitable for easy teaching and learning a song. The words of the song are placed on a musical staff with optional cleft, key signature, and time signature at the level at which the notes would appear in the standard notation system. Different fonts are used to indicate whether the note should be regarded as a sharp, a flat, or a natural. Non-numeric symbols are used to indicate the duration of the note, and may be placed above or below the words of the song.

### CROSS REFERENCE TO RELATED APPLICATIONS

The present application is a continuation in part of U.S. Design Patent Application No. 29/225,266 filed Mar. 15, 2005.

### FIELD OF THE INVENTION

This invention relates to a method of music notation, more particularly a method for music notation of songs. Application of the method necessarily produces a score of music which is a useful article of commerce. Thus the invention relates to an article of manufacture. Finally, a score of music necessarily produced by this invention is especially useful for teaching or learning a song. Thus the invention also relates to a method of teaching or learning a song using a score of music produced by the method described herein.

### BACKGROUND OF THE INVENTION

Music has been a great joy to mankind throughout all of history, but it was only within the last 4-500 years that a general system for recording instructions for how music should be played has become widely accepted. In the present application we use the term written musical score to indicate these instructions whether written, printed or displayed as on a computer screen, as a result of a system of music notation. The history of musical notation systems has been reviewed in many places for example by Karl W. Gehrkens in “Music Notation and Terminology” (The A. S. Barnes Co., NY) 1914, and is hereby incorporated by reference in its entirety. By such works it can be seen that the invention of movable type and the associated printing press caused a standardization of musical notation for all instruments in use in the western world. This standardization has recognized that the pitch and tempo of music can be most effectively conveyed by the use of symbols rather than numerals, and notes disposed on a musical staff was more efficient than other methods employing for example numbers, for achieving that purpose. The value of the printing press for the dissemination, sale, and distribution of music has been a great boon for the music industry, and for the enjoyment of all.

However, with the advent of the computer, and more sophisticated means of displaying, writing, and printing there is opportunity for greater freedom in the display of musical forms resulting in greater utility in communicating instructions for musical performance. The present invention uniquely recognizes certain aspects of choral performance which are not well served by the standard method of musical notation. Such standard method as it is practiced in modern times is thoroughly described in such works as Gamer Read's “Music Notation: A Manual of Modern Practice” 2^{nd} edition (Allyn and Bacon, Inc., Boston, Mass.) 1969 which is hereby incorporated by reference in its entirety. This work describes the standard music notation system based on a musical staff containing a clef, an optional key signature, time signature, and notes.

This standard notation system conveys among other things information about the exact pitch of the notes to be played by a combination of the vertical position of the note on the staff, and whether the note is to be regarded as sharp, flat, or natural. For example in music written for the piano with no key signature, or more precisely with no sharps or flats in its key signature, may be played on the white keys of the piano unless directed by the composer to sharp or flatten a specific note. Music which contains a key signature inherently tells the pianist to play one of the black keys adjacent to one or more indicated notes every time that note is encountered unless otherwise directed. Those skilled in reading music will remember which black keys need to be played for a given key signature, but less skilled musicians my have to refer to the key signature from time to time in order to properly play the music.

Music intended to be performed by the human voice is commonly referred to as songs. This type of music has thus far been represented with a musical staff in much the same way as music designed to be played on any other musical instrument, but with the words to be sung added below or above the staff. Singers tend to be less skilled at reading music and often have difficulty remembering whether a given note is to be sung as its associated sharp or flat. Thus they often have to refer to the key signature when learning a song.

In the present disclosure the words of the song refers to the syllables, words, or sounds to be sung that correspond to the particular notes that would be displayed in this standard musical notation. Before the present invention these words have been placed above or below the musical staff causing the singers eye to be forced to move down below the staff to read the word to be sung, back up to recognize in the note of music, and often across to the key signature to check to see if the note should be regarded as sharp, flat, or natural according to the key signature. Such optical gymnastics places a considerable burden on the singer particularly when first learning the song or when the singer is unfamiliar with the particular key signature employed.

U.S. Pat. No. 881,085 to Shires disclosed a music notation system which attempted to partially remedy this difficulty by placing the words to be sung on the musical staff itself at the level of their corresponding notes, but the method still required the singer to refer to the key signature. Moreover according to this method, a numeral was employed above the words to convey the appropriate duration or tempo for the words. The use of numerals sacrificed the advantage of the non-numeric symbols preferred by musicians for the last 500 years, and causes the performer to make a mental conversion from a numerical value to a tempo as the song is sung.

The present invention takes advantage of the capabilities associated with the modern computer to remedy the difficulties that previous methods of music notation have caused singers. For example, it is now quite easy to change the font of letters printed, or displayed. Moreover it is easy to change from normal thickness of letters to a bold thickness of letters with a simple click of a mouse. By this method more information can be indicated to the reader than is actually contained in the words themselves. By skillful and judicious use of these capabilities the invention allows the singer to simultaneously read the word to be sung, and perceive precisely its pitch (including whether it is a sharp, flat, or natural).

Moreover, the invention does not require the conversion from a number representing duration to a duration experienced by the performer as a period of time. The singer can learn to associate a symbol with a period of time, and an extra mental step of conversion would not be necessary. These advantages have been shown by experimentation to result in songs being much easier to learn when the music notation system described herein is employed. Symbols have the advantage of having the opportunity to be perceived directly as duration in time, while a number is usually perceived as a numeric value which may be converted to duration in time. In much the same way a short or long distance can be experienced by traveling various distances. The experience of traveling a short distance is then associated with the concept of a short distance directly. However, when the distance is described numerically one must evaluate the number to assess whether it refers to short or long distance. Moreover, one can look at a series of lines of different length and evaluate easily which is the longest and which is the shortest. In order to evaluate the same qualities in a list of numbers is more difficult. The value of each number must be compared to the value of the other numbers. Thus numeric values are perceived less efficiently than symbolic values in ways that make perception of duration and tempo better represented by symbolic ones.

Although experienced music readers and novice musicians alike have found this new system valuable, the system is particularly beneficial for those who have little formal training in reading music. Those who are not skilled in reading music will have to refer back to the key signature to determine if a given note is a flat a sharp or a natural. Such reference is uniquely unnecessary for the music notation system of the present invention.

### SUMMARY OF THE INVENTION

An object of the present invention is to enable singers to read and learn songs more easily by not requiring the singer to remember the key signature, or make reference to it to determine if a given note is to be a sharp, flat, or natural.

Another object of the invention is to allow singers to perceive both the word and exact pitch to sing simultaneously without requiring a vertical movement of the eye, by a means which does not also impose the burden to make a conversion from a number to a tempo.

At least one of these objects is addressed, in whole or in part, by the present invention. The invention is a method of music notation for songs; a musical score resulting from the application of the method of musical notation; and a method of teaching or learning a song using a musical score based on the method of music notation.

### SHORT DESCRIPTION OF DRAWINGS

The summary above, and the following detailed description will be better understood in view of the enclosed drawings which depict details of preferred embodiments. It should however be noted that the invention is not limited to the precise arrangement shown in the drawings and that the drawings are provided merely as examples.

FIG. 1 shows a staff of music with the words placed at the level of their corresponding notes in normal font when the notes would be played on the white keys of a piano, and in bold font when the notes would be played on the black keys of a piano. It also shows non-numeric oval symbols indicating the duration of each note or the overall temp.

FIG. 2 shows non-numeric oval symbols to indicate the duration of each note.

### DETAILED DESCRIPTION OF THE PREFERRED EMBODIMENTS

While the invention will be described in connection with one or more embodiments, it will be understood that the invention is not limited to those embodiments. On the contrary, the invention includes all alternatives, modifications and equivalents as may be included within the spirit and scope of the appended claims.

One aspect of the present invention is a method of music notation for a song comprising a musical staff with optional cleft symbol, key signature, and time signature in which the words to be sung are placed on the staff at the vertical position of the corresponding note, but in a font indicating whether or not the note is to be regarded as a flat, a sharp, or a natural.

In one embodiment the words are written in normal thickness letters if the note is a natural, and would be played on the white keys of a piano, or in bold thickness if the note is a sharp or flat and would be played on the black keys of a piano.

In another embodiment, notes that are to be played as sharp are made bold and written in forward leaning italics, while notes that are to be played as flat are made bold and written in backward leaning italics.

Another aspect of the present invention is the use of a non-numeric symbol to indicate the duration of a note, and along with the duration of several neighboring notes taken together, the overall tempo.

The non-numeric symbol indicating duration may be placed below or above its corresponding word in close enough proximity as to make it easily visible when the word is read.

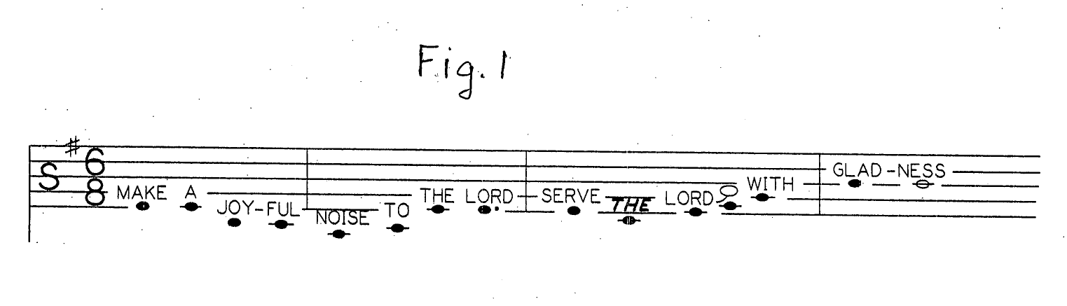

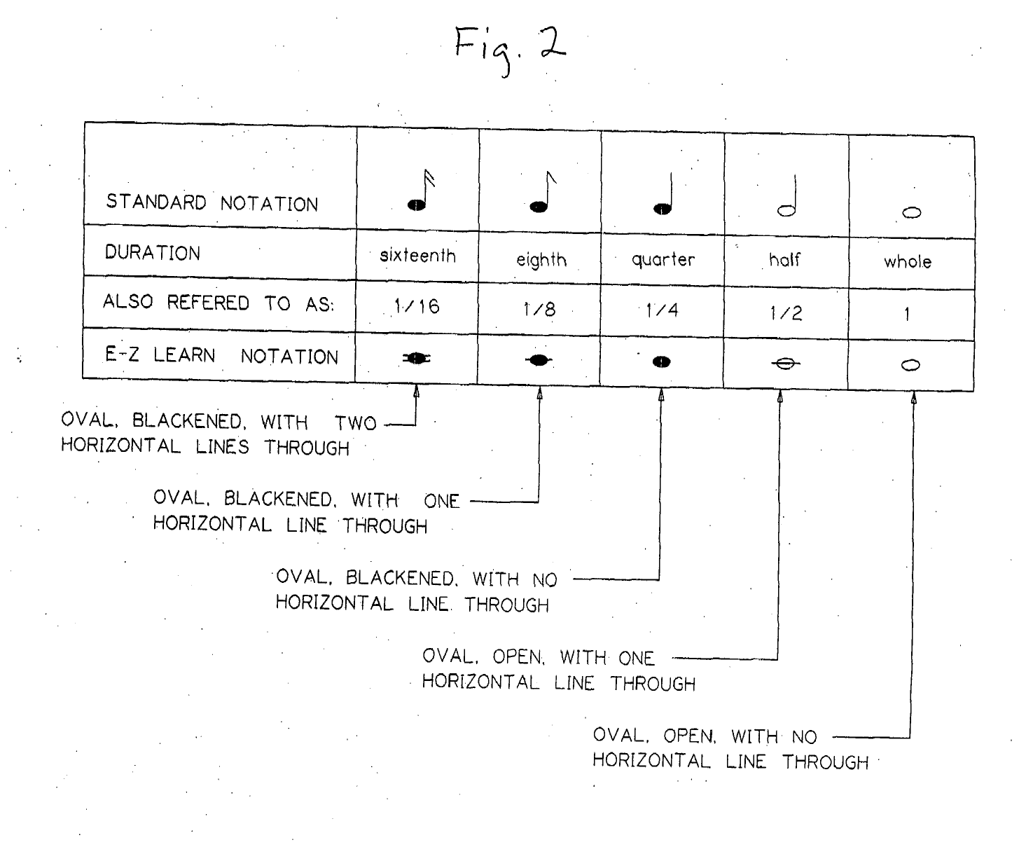

An appropriate example of the invention is shown in FIG. 1. Oval symbols used to indicate duration may be seen listed in FIG. 2.

It will be appreciated that the invention is not limited to what has been described hereinabove merely by way of example. While there have been described what are at present considered to be the preferred embodiments of this invention, it will be obvious to those skilled in the art that various other embodiments, changes, and modifications may be made therein without departing from the spirit or scope of this invention and that it is, therefore, aimed to cover all such changes and modifications as fall within the true spirit and scope of the invention, for which letters patent is applied.

What is claimed is:

1. A method of music notation for a song comprising a musical staff on which are placed the words to be sung at the level of their corresponding notes, and said words being written in different fonts according to whether they correspond to flat, sharp or natural notes.

2. A method of music notation for a song comprising a musical staff on which are placed the words to be sung at the level of their corresponding notes, and said words being written in bold type if the note corresponding to the word would be played on a black key of a piano.

3. A method of music notation for a song according to claim 2 in which the bold type words are written in forward leaning italic font if the note is a sharp, and written in backward leaning italic font if the note is a flat.

4. A written musical score for a song comprising a musical staff on which the words to be sung are placed at the level of their corresponding notes, and each word being written either in bold type if the note corresponding to the word would be played on a black key of a piano; or alternatively in normal type if the note corresponding to the word would be played on a white key of a piano.

5. A written musical score for a song according to claim 4 in which the bold type word is written in forward leaning italic font if the note corresponding to the word is a sharp, and alternatively written in backward leaning italic font if the note corresponding to the word is a flat.

6. A written musical score for a song according to claim 4 or 5 in which a non-numeric symbol indicating the duration of the note is placed below the word to be sung.

7. A written musical score for a song according to claim 4 or 5 in which a non-numeric symbol indicating the duration of the note is placed above the word to be sung.

8. A written musical score for a song according to claim 6 or 7 in which the symbols designating the duration of the note are as follows: a blackened oval elongated in the horizontal direction with no horizontal line through it to indicate a quarter note; an open oval with a horizontal line through it to indicate a half note; an open oval with no horizontal line through it to indicate a whole note; a blackened oval with a horizontal line through it to indicate an eighth note; and a blackened oval with two horizontal lines through it to indicate a sixteenth note.

9. A method of teaching a song using a written musical score according to any of claims 4, 5, 6, 7 or 8.

10. A method of learning a song using a written musical score according to any of claims 4, 5, 6, 7 or 8.
